(19) United States
(12) Patent Application Publication
(10) Pub. No.: US 2005/0076550 A1
(43) Pub. Date: Apr. 14, 2005

(54) Orientation indicator system

(76) Inventor: Terry J. Sills, Mesa, AZ (US)

Correspondence Address: SANDRA L. ETHERTON;ETHERTON LAW GROUP, LLC, PO BOX 27843, TEMPE, AZ, 85285-7843, US

(21) Appl. No.: 10/684,303

(22) Filed: Oct. 10, 2003

(51) Int. Cl. B42F 1/00

(52) U.S. Cl. 40/371; 40/427; 359/1; 116/209

(57) ABSTRACT

An apparatus and method for improved orientation indication. Reference markers are applied to a display and are used to convey orientation information. A reference marker becomes visible when conditions of proper or improper orientation exist. Preferably approving facial expressions are used to indicate proper orientation and non-approving facial expressions are used to indicate improper orientation.

### FIELD OF INVENTION

This invention relates generally to indicia intended to convey orientation information to a person in close proximity to the display medium. This invention relates particularly to utilizing reference markers to convey orientation information of an object to a person using that object.

### BACKGROUND

Typically, improper orientation of an object during use can result in wasted time, physical injury, and property damage. Take for example the case of a person spraying insecticide or paint with a spray bottle. If a person inadvertently sprays the contents at him- or herself, the user could be harmed. It would be desirable to easily determine the proper orientation of the spray bottle prior to spraying. For another example, use of a spray bottle when the valve orientation is in a closed position results in wasted time as the user struggles to produce an open valve orientation. Furthermore, the bug spray bottle user may very easily break off the spray handle as a result of squeezing the handle while the valve is oriented in a closed position. Even worse, if a spray bottle of hazardous substance is unknowingly left with the valve orientation in an open position, small children could very easily suffer physical harm by handling the bug spray bottle and discharging the hazardous chemicals inside. It would be desirable to easily determine the proper orientation of the valve. As a result, development of a simple and convenient orientation indication system is highly desirable.

A primary object and feature of the present invention is to provide a system for improved orientation indication where proper orientation is essential for safe and effective use of an object. It is a further object and feature of the present invention to provide such an orientation indication utilizing reference markers, and preferably those reference markers are universally understood, such as facial indicia. Another object of the present invention is to provide such a system that is substantially visible when proper orientation exists between an object and a user. Other objects and features of this invention will become apparent with reference to the following descriptions.

### SUMMARY OF THE INVENTION

The present invention is an apparatus and method for improved orientation indication where proper orientation is essential for safe and effective use of an object. Reference markers are applied to a display and are used to convey orientation information. A reference marker becomes visible when conditions of proper or improper orientation exist. Preferably approving facial expressions are used to indicate proper orientation and non-approving facial expressions are used to indicate improper orientation.

### BRIEF DESCRIPTION OF THE DRAWINGS

FIG. 1 is a perspective view of the indicator system employing a notepad.

FIG. 2 is a perspective view of the indicator system according to a preferred embodiment of the present invention.

FIG. 3 is a perspective view of the indicator system according to another embodiment of the present invention.

FIG. 4 is a top view of a valve embodying the present invention.

FIG. 5 is a top view of a valve, repositioned with respect to FIG. 4, according to another embodiment of the present invention.

FIG. 6 is a side view of a spray bottle.

FIG. 7 is a rear view of the spray bottle, implementing the present invention.

FIG. 8 is a front view of the spray bottle, implementing the present invention.

FIG. 9 is a plan view of smiling facial indicia of the present invention.

FIG. 10 is a plan view of frowning facial indicia of the present invention.

### DETAILED DESCRIPTION OF THE INVENTION

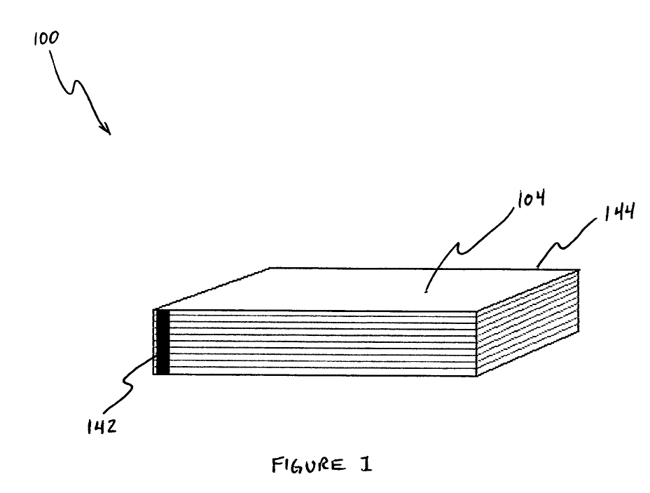

FIG. 1 is a perspective view of a notepad employing the present indicator system 100, which comprises a display 104 and a reference marker 142. In this example, display 104 is properly oriented when bound edge 144 of the notepad is facing away from the user. Reference marker 142 is substantially visible when proper orientation of the notepad exists, as shown in FIG. 1, indicating to a system 100 user that display 104 is properly oriented. Preferably the reference marker is of a color that differs from that of the display, so as to be conspicuous. In FIG. 1, reference marker 142 is a bar of darker color than the notepad. Under appropriate circumstances, considering issues such as manufacturing, cost, style, etc., other reference markers 142, such as faces, lines, dots, stars, hearts, circles, and other shapes etc., in the same and other locations and colors, may also suffice.

FIG. 2 is a perspective view of the indicator system according to a preferred embodiment of the present invention. System 100 utilizes universally-recognized reference markers comprising facial indicia that indicate approval when the system is oriented properly, and such indicia are referred to herein as approving facial indicia. The facial indicia are substantially visible when proper orientation exists between an object and a user, as shown in FIG. 2. Preferably, the approving facial indicia comprise one or more smiling facial indicia, commonly referred to as a smiley face 106, which further comprises a smiling mouth 130, as an upwardly curved line, and two dotted eyes 132, as shown in FIG. 2. Under appropriate circumstances, considering issues such as the nature of the object being oriented, cost, culture, etc., other mouths such as round, grinning, teeth, etc., may suffice for the smiling mouth. Similarly, winking, wide open, glancing, closed, etc., and other eyes may suffice for the eyes.

Display 104 is any visible surface related to an object requiring proper orientation in order to be used safely or effectively. Preferably, display 104 comprises an essential portion of the object being oriented, however, non-essential portions, such as an extraneous object in the vicinity of the object being oriented (which may improve visibility of facial indicia), may also serve as display 104.

Preferably, display 104 is a notepad 114, as shown in FIG. 2. Preferably the notepad 114 comprises Post-It® notes. Post-It® notes are sheets of paper having repositionable adhesive along one edge, which may be bound together by their own adhesive. They are available commercially from the 3M Corporation. For typical use, notepad 114 is properly oriented when bound edge 116 faces away from the user. Under appropriate circumstances, considering issues such as style, cost, market demand, etc., other notepads 114, such as round, heart-shaped, non-rectangular, non-sticky, etc., may suffice.

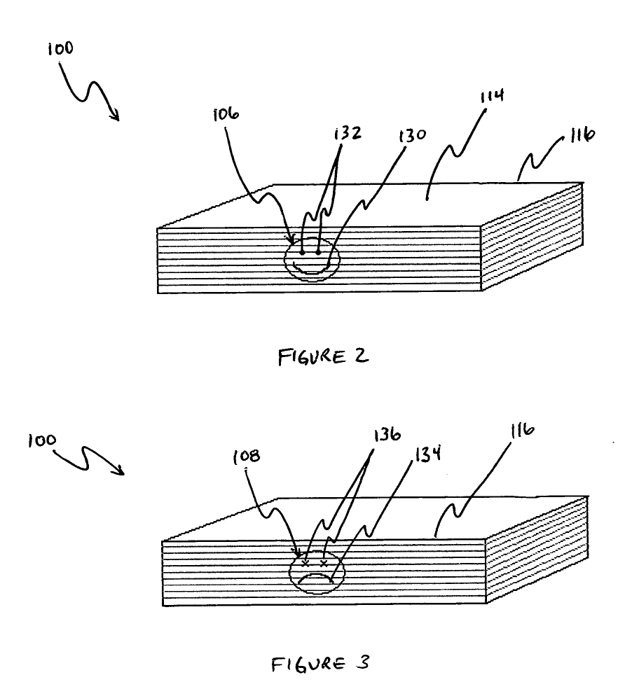

FIG. 3 is a perspective view of the indicator system according to another embodiment of the present invention. System 100 utilizes reference markers comprising facial indicia that indicate disapproval when the system is oriented improperly, and such indicia are referred to herein as non-approving facial indicia. The non-approving facial indicia are substantially visible when improper orientation exists between an object and a user, as shown in FIG. 3. Preferably, the non-approving facial indicia comprise one or more frowning facial indicia. Preferably, the frowning facial indicia comprise a frowning mouth 134, as a downwardly curved line, and two blitzed eyes 136 as shown in FIG. 3. Under appropriate circumstances, considering issues such as the nature of the object being oriented, cost, culture, etc., other mouths such as straight, smirking, round, tongue stuck out, etc., may suffice for the frowning mouth. Similarly, pouting, wide open, glancing, closed, with furrowed brows, etc., may suffice for the blitzed eyes.

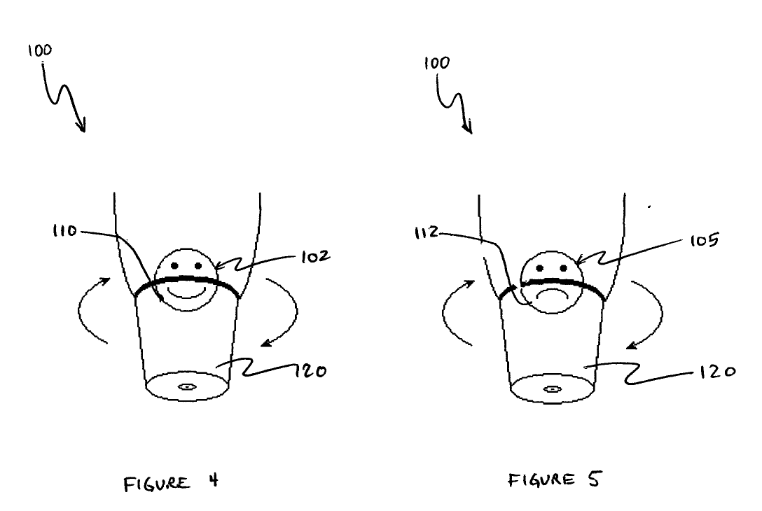

FIG. 4 is a top view of a valve embodiment of the present invention. The display comprises valve 120 for manipulating fluid flow. Valve 120 provides for open and closed orientations, and such is communicated utilizing facial indicia. Valve 120 is rotatable, and the facial indicia are applied across the plane of rotation, which enables the displayed facial indicia to change depending on the valve orientation. For an approved fluid flow, the approving facial indicia 102 are visible to the user, as the lower portion 110 of the facial indicia comprising the smile mouth is aligned under the dotted eyes, as in FIG. 4. FIG. 5 is a top view of the valve, repositioned with respect to FIG. 4, and indicating a non-approved fluid flow. In FIG. 5, the non-approving facial indicia 105 are visible, as the lower portion 112 of the facial indicia comprising the frowning mouth is aligned under the dofted eyes. Under appropriate circumstances, considering issues such as flow function, cost, manufacturing, etc., other displays 104, such as thresholds, lids, doors, closers, etc., may be used as the display.

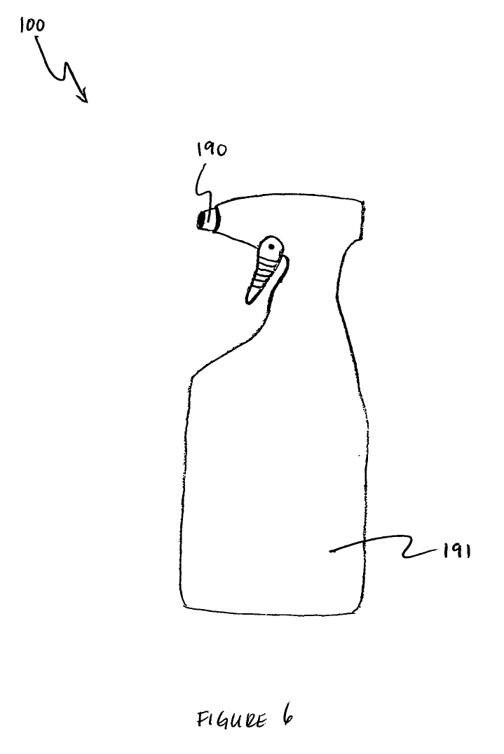

FIG. 6 is a side view of a spray bottle employing the present invention, which is example of an aimable object requiring proper orientation between an object and a user in order to be safe and effective. Display comprises spray bottle 191, which further comprises valve 190 from which the spray emanates. Other aimable objects include, but are not limited to, guns, nozzles, canisters, non-spray bottles, etc.

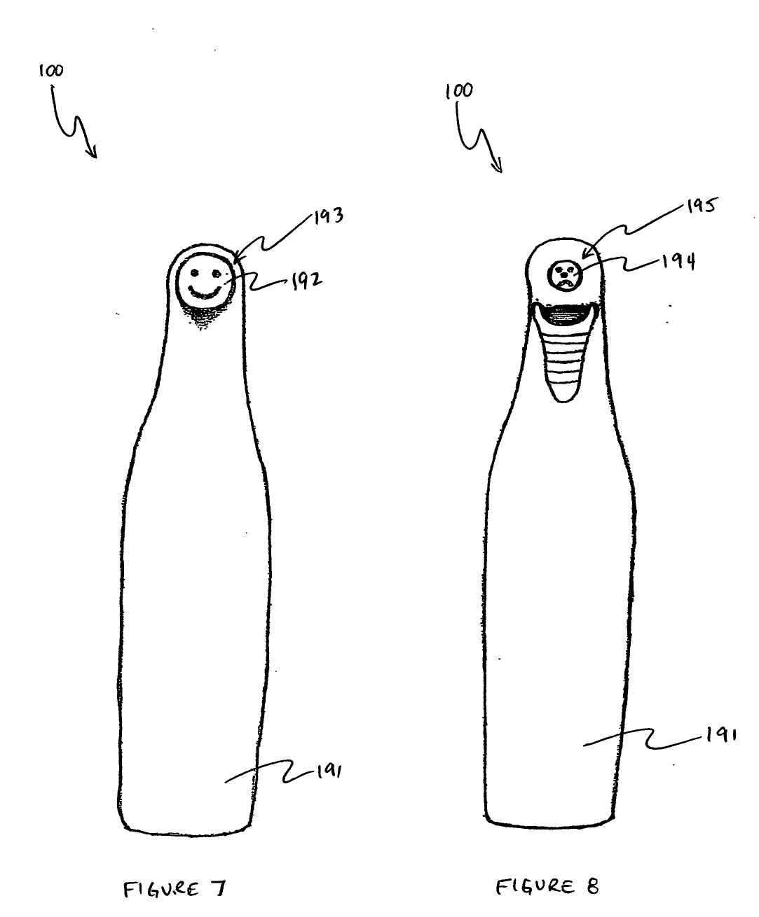

FIG. 7 shows the back side of spray bottle 191 which, assuming that spraying oneself is undesirable, should substantially face the user when the spray bottle is in use. Therefore, approving facial indicia are applied to this proximal side of the spray bottle 191 to indicate to a user that the user is aiming in a proper direction. That is, when the user orients the smiley face 192 towards him- or herself, the spray will emanate from the other side of the spray bottle 191, away from the user. Frowning facial indicia 194 may be applied to the distal side of the spray bottle 191 to indicate to a user that, when the user sees the frowning indicia, the user is aiming in an improper direction. Of course, if the user desires to spray him- or herself, the smiley face would be on the side from which the spray emanates.

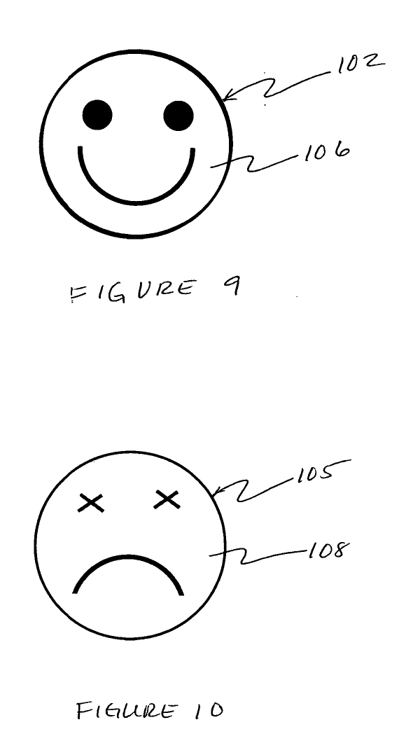

FIG. 9 shows one version of a smiley face 106. FIG. 10 shows one version of frowning facial indicia 108.

Although the above descriptions provide applicant's preferred embodiments of this invention, it will be understood that the broadest scope of this invention includes such modifications as diverse shapes and sizes, as well as diverse materials and colors. In addition, equivalents may be substituted for elements thereof without departing from the true scope of the invention. Such scope is limited only by the below claims as read in connection with the above specification. Furthermore, many other advantages of applicant's invention will be apparent, to persons of ordinary skill in the art, as a result of the above descriptions and as a result of the below claims.

1. An object orientation indicator system for conveying when proper orientation exists between an object and a user, the system comprising:
a) at least one reference marker; and
b) at least one display;
wherein at least one reference marker is located on at least one display so as to be substantially visible when proper orientation exists between the object and the user.

2. The system according to claim 1 wherein at least one reference marker comprises at least one facial indicium.

3. The system according to claim 2 wherein at least one reference marker comprises at least one approving facial indicium.

4. The system according to claim 3 wherein at least one reference marker comprises at least one smiling facial indicium.

5. The system according to claim 4 wherein at least one reference marker comprises at least one non-approving facial indicium.

6. The system according to claim 5 wherein at least one reference marker is a smiley face.

7. The system according to claim 2 wherein at least one reference marker comprises at least one frowning facial indicium.

8. The system according to claim 1 wherein the display is a notepad and at least one reference marker conveys whether the notepad is oriented such that at least one bound edge is in a position for effective use of the notepad by the user.

9. The system according to claim 8 wherein the notepad comprises at least one Post-It® note.

10. The system according to claim 1 wherein:
a) the display comprises a spray bottle having a distal side and a proximal side; and
b) the proximal side has at least one approving facial indicium; such that when the spray bottle is held in proper position by the user, an approving facial indicium is visible to the user.

11. The system according to claim 1 wherein at least one display comprises at least one valve, and at least one reference marker indicates to the user whether at least one valve is substantially opened or substantially closed.

12. The system according to claim 11 wherein at least one reference marker comprises at least one facial indicium.

13. The system according to claim 11 wherein at least one reference marker comprises at least one smiling facial indicium.

14. The system according to claim 11 wherein at least one reference marker comprises at least one smiley face.

15. The system according to claim 11 wherein at least one reference marker comprises at least one frowning facial indicium.

16. An object orientation indicator system for conveying when proper orientation exists between an object and a user, the system comprising:
a) means for conveying orientation information; and
b) means for displaying the means for conveying;
c) wherein the means for conveying is positioned on the means for displaying so as to be substantially visible when proper orientation exists between the object and the user.

17. The system according to claim 16 wherein the means for conveying comprises facial expressions.

18. The system according to claim 16 wherein the means for conveying comprises approving facial expressions.

19. The system according to claim 16 wherein the means for displaying is a notepad, and the means for conveying indicates to the user whether the notepad is oriented such that at least one bound edge is in proper position for effective use of the notepad.

20. The system according to claim 19 wherein the notepad comprises at least one Post-It® note.

21. The system according to claim 19 wherein:
a) the display comprises a spray bottle having a distal side and a proximal side; and
b) the proximal side has at least one approving facial indicium; such that when the spray bottle is held in proper position by the user, an approving facial indicium is visible to the user.

22. The system according to claim 21 wherein the approving facial indicium is a smiley face.

23. The system according to claim 16 wherein the means for displaying comprises means for flow manipulation, such that the means for conveying indicates whether the means for flow manipulation is substantially opened or substantially closed.
